(19) United States
(12) Patent Application Publication
(10) Pub. No.: US 2025/0335984 A1
(43) Pub. Date: Oct. 30, 2025

(54) METHOD FOR OPERATING CREDIT EVALUATION MODEL USING TWO-STEP LOGISTIC REGRESSION ANALYSIS AND SERVER FOR PERFORMING SAME

(71) Applicant: KAKAOBANK CORP., Seoul (KR)

(72) Inventors: Jin Ho SHIN, Seoul (KR); Sung Hyon KYEONG, Seoul (KR); Dae Hee KIM, Seoul (KR)

(21) Appl. No.: 18/717,931

(22) PCT Filed: Dec. 1, 2022
(86) PCT No.: PCT/KR2022/019405

§ 371 Date: Dec. 27, 2024

(30) Foreign Application Priority Data
Dec. 9, 2021 (KR) 10-2021-0175720

(51) Int. Cl. G06Q 40/03; G06F 16/28

(52) U.S. Cl. CPC G06Q 40/03; G06F 16/285

(57) ABSTRACT

A credit evaluation model operating method performed by a credit evaluation server linked to a financial server, the credit evaluation model operating method comprising, a step of receiving log data of a user and selecting basic variable items included in the log data, a step of generating candidate variables by calculating a frequency of the basic variable items in the log data, a step of generating a plurality of first derived variables by applying different time windows or different calculation methods to the candidate variables, a step of selecting important variables by comparing values related to the plurality of first derived variables with a predetermined standard value, a step of deriving a first-step model by using the important variables as input variables and using information on the user's credit as a dependent variable, a step of selecting a first final variable to be applied to the first-step model among the important variables and calculating a first weighted value for the first final variable, a step of generating a second derived variable by using the first final variable and the first weighted value, a step of deriving a second-step model by using the second derived variable as an input variable and using information on the user's credit as a dependent variable, and a step of selecting a second final variable to be applied to the second-step model from among the first derived variables and calculating a second weighted value for the second final variable.

### DESCRIPTION

### Technical Field

The present invention relates to a credit evaluation model using two-step logistic regression analysis and a server that performs the same. Specifically, the present invention relates to a method of operating a two-step logistic regression model to improve the performance of a credit evaluation model using log data of a user.

### Background Art

The description of this part simply provides background information on the present embodiment and does not constitute prior art.

Recently, as financial institutions or electronic financial companies provide financial products and services through computing devices, the number of financial transactions performed online without meeting of users with employees of financial institutions or electronic financial companies in person has been increased. However, as channels providing financial transactions are diversified and transaction volume increases, a default rate of financial transactions is also increasing at a rapid rate. Accordingly, the importance of methods for accurately and quickly assessing and predicting a user's creditability in financial transactions is increasing day by day.

Most banks and other retail financial companies at home and abroad use logistic regression to develop credit evaluation models, and logistic regression analysis models may only use up to 10 explanatory variables for a model due to multicollinearity that the explanatory variables have to be linearly independent of each other. That is, even when variables in a new information domain are discovered, existing variables may not be used due to limitations of linear independence, and accordingly, there was a limit to improving the performance of a model. That is, when linear independence between explanatory variables is decreased, there was a problem in which statistical significance of the explanatory variables was underestimated.

Meanwhile, recently, there have been increasing attempts to use machine learning or deep learning technology that may improve the predictive performance of credit evaluation models by using more variables. However, because the technology has no restrictions on explanatory variables, there is an advantage of being able to utilize all available information, but a functional relationship between explanatory variables and prediction results may not be identified, and accordingly, in a financial business field that requires explanatory power, there was a limit that the technology was difficult to be used.

### SUMMARY OF INVENTION

### Technical Problem

An object of the present invention is to provide a method for operating credit evaluation model providing a two-step credit evaluation model that may improve the performance of a credit evaluation model by using more explanatory variables while fully maintaining the explanatory power of the credit evaluation model.

In addition, an object of the present invention is to provides a credit evaluation model operating method of rating a creditability of a user by generating important variables with high explanatory power based on a user's log data and by performing a second-step logistic regression analysis by using derived variables selected through a first-step logistic regression analysis based thereon.

Objects of the present invention are not limited to the objects described above, and other objects and advantages of the present invention that are not described above may be understood by following descriptions and will be more clearly understood by embodiments of the present invention. Also, it will be readily apparent that objects and advantages of the present invention may be implemented by means and combinations thereof indicated in the patent claims.

### Solution to Problem

According to some aspects of the disclosure, a credit evaluation model operating method performed by a credit evaluation server linked to a financial server, the credit evaluation model operating method comprises, a step of receiving log data of a user and selecting basic variable items included in the log data, a step of generating candidate variables by calculating a frequency of the basic variable items in the log data, a step of generating a plurality of first derived variables by applying different time windows or different calculation methods to the candidate variables, a step of selecting important variables by comparing values related to the plurality of first derived variables with a predetermined standard value, a step of deriving a first-step model by using the important variables as input variables and using information on the user's credit as a dependent variable, a step of selecting a first final variable to be applied to the first-step model among the important variables and calculating a first weighted value for the first final variable, a step of generating a second derived variable by using the first final variable and the first weighted value, a step of deriving a second-step model by using the second derived variable as an input variable and using information on the user's credit as a dependent variable, and a step of selecting a second final variable to be applied to the second-step model from among the first derived variables and calculating a second weighted value for the second final variable.

According to some aspects, the step of selecting the variable basic items includes selecting the variable basic items corresponding to event codes by classifying the event codes included in the log data by using a predetermined category and classifying the event codes belonging to the category by using a plurality of predetermined features.

According to some aspects, the step of generating the candidate variables includes calculating a term frequency (TF) and a term frequency-inverse document frequency (TF-IDF) of the variable basic items and generating the candidate variables, and the term frequency (TF) is calculated by using a simple frequency, a Boolean frequency, an incremental frequency, or a log frequency, and the term frequency-inverse document frequency (TF-IDF) is calculated by multiplying the term frequency (TF) by the term frequency-inverse document frequency (TF-IDF).

According to some aspects, the step of generating the plurality of first derived variables includes generating the first derived variables by using one of a plurality of time windows of different sizes and one of a plurality of calculation methods for the candidate variable, the time windows are able to be set to different periods, and the calculation methods include an average, a sum, a maximum value, and a minimum value.

According to some aspects, the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and the IV value is derived by an <equation> below.

$$I V = {\sum }_{i} ( \% of Goods - \% of Bads ) \times W O {E}_{i} \qquad \text{<Equation>}$$

where, ‘% of Goods’ means an entire ratio of a group evaluated as good, ‘% of Bads’ means an entire ratio of a group evaluated as bad, and WOE (Weights of Evidence; hereinafter WOE) means a value obtained by performing a natural logarithm on a value of the ratio of the group evaluated as good compared to the ratio of the group evaluated as bad.

According to some aspects, a step of grouping variables belonging to a same information domain (F) for the selected important variables, and wherein the step of deriving the first-step model includes selecting the first final variable targeting the important variables included in a certain information domain (F).

According to some aspects, the first-step model and the second-step model consist of a logistic regression model.

According to some aspects, the first-step model selects the first final variable to be applied to the first-step model from among the important variables by using a step-wise selection method, and the second-step model selects the second final variable to be applied to the second-step model from among the second derived variables by using the step-wise selection method.

According to some aspects, a step of performing a credit rating of a new user based on log data of the new user by using the first-step model to which the first final variable is applied and the second-step model to which the second final variable is applied.

According to some aspects of the disclosure, A credit evaluation model operating method performed by a credit evaluation server linked to a financial server, the credit evaluation model operating method comprises, a step of receiving log data of a user and selecting a frequency of event codes included in the log data and important variables through at least one preprocessing process for the frequency, a step of deriving a first-step logistic regression mode by using the important variables as input variables and using information on the user's credit as a dependent variable, a step of selecting a first final variable to be applied to the first-step model among the important variables and calculating a first weighted value for the first final variable, a step of generating a derived variable by using the first final variable and the first weighted value, a step of deriving second-step logistic regression model by using the derived variable as an input variable and using information on the user's credit as a dependent variable, and a step of selecting a second final variable to be applied to the second-step model from among the derived variables and calculating a second weighted value for the second final variable.

According to some aspects, the first-step model selects the first final variable to be applied to the first-step model from among the important variables by using a step-wise selection method, and the second-step model selects the second final variable to be applied to the second-step model from among the second derived variables by using the step-wise selection method.

According to some aspects, the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and the IV value is derived by an <equation> below.

$$I V = {\sum }_{i} ( \% of Goods - \% of Bads ) \times W O {E}_{i} \qquad \text{<Equation>}$$

where, ‘% of Goods’ means an entire ratio of a group evaluated as good, ‘% of Bads’ means an entire ratio of a group evaluated as bad, and WOE (Weights of Evidence; hereinafter WOE) means a natural logarithm of the group evaluated as good relative to the group evaluated as bad.

According to some aspects, a step of grouping variables belonging to a same information domain (F) for the selected important variables, and wherein the step of deriving the first-step model includes selecting the first final variable targeting the important variables included in a certain information domain (F).

According to some aspects, a step of performing a credit rating of a new user based on log data of the new user by using the first-step model to which the first final variable is applied and the second-step model to which the second final variable is applied.

According to some aspects of the disclosure, a credit evaluation server comprises, a processor, a memory configured to load a computer program executed by the processor; and an interface configured to exchange data generated during execution of the computer program with a user terminal, wherein the computer program includes, a step of receiving log data of a user from the user terminal and selecting a frequency of event codes included in the log data and important variables through at least one preprocessing process for the frequency, a step of deriving a first-step logistic regression mode by using the important variables as input variables and using information on the user's credit as a dependent variable, a step of selecting a first final variable to be applied to the first-step model among the important variables and calculating a first weighted value for the first final variable, a step of generating a derived variable by using the first final variable and the first weighted value, a step of deriving second-step logistic regression model by using the derived variable as an input variable and using information on the user's credit as a dependent variable, and a step of selecting a second final variable to be applied to the second-step model from among the derived variables and calculating a second weighted value for the second final variable.

According to some aspects, the first-step model selects the first final variable to be applied to the first-step model from among the important variables by using a step-wise selection method, and the second-step model selects the second final variable to be applied to the second-step model from among the second derived variables by using the step-wise selection method.

According to some aspects, the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and the IV value is derived by an <equation> below.

$$I V = {\sum }_{i} ( \% of Goods - \% of Bads ) \times W O {E}_{i} \qquad \text{<Equation>}$$

where, ‘% of Goods’ means an entire ratio of a group evaluated as good, ‘% of Bads’ means an entire ratio of a group evaluated as bad, and WOE (Weights of Evidence; hereinafter WOE) means a natural logarithm of the group evaluated as good relative to the group evaluated as bad.

According to some aspects, a step of grouping variables belonging to a same information domain (F) for the selected important variables, and wherein the step of deriving the first-step model includes selecting the first final variable targeting the important variables included in a certain information domain (F).

According to some aspects, a step of performing a credit rating of a new user based on log data of the new user by using the first-step model to which the first final variable is applied and the second-step model to which the second final variable is applied.

According to some aspects, a computer-readable recording medium in which a program capable of executing the method according to any one of claims 1 to 14 is recorded.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

### Advantageous Effects

The credit evaluation model operating method of the present invention may develop a credit evaluation model with more than 100 variables, and at the same time, provide a credit evaluation model that may completely explain a corresponding model. That is, even when many variables are used, an initial variable value and a final predicted value for a model are expressed in a linear relationship. and a complete explanation may be made, and thus, usability for the financial business field and reliability of a credit evaluation model may be increased.

Also, the credit evaluation model operating method of the present invention generates a credit evaluation model based on log data of a user and provides an existing logistic regression model in two steps, and thus, performance of the credit evaluation model may be improved without additional costs. Also, since log data related to applications that are not used at all in the existing credit evaluation model may be additionally utilized, improvement of differentiated performance indexes for credit rating may be expected.

In addition to the above description, specific advantages of the present invention are described below while describing specific details for implementing the invention.

### BRIEF DESCRIPTION OF THE DRAWINGS

FIG. 1 is a diagram illustrating a credit evaluation model operating system according to some embodiments of the present invention.

FIG. 2 is a diagram illustrating the credit evaluation server of FIG. 1.

FIG. 3 is a block diagram illustrating a credit evaluation model operating method according to some embodiments of the present invention.

FIG. 4 is a table illustrating an example of categories and features for selecting basic variable items of FIG. 3.

FIG. 5 is a block diagram illustrating a method of generating a first derived variable of FIG. 3.

FIG. 6 is a block diagram illustrating a relationship between a two-step logistic regression model used in step S50 to step S70 of FIG. 3.

FIG. 7 is a block diagram illustrating an example of variable items for rating a user's credit by using a two-step logistic regression model.

FIG. 8 is a flowchart illustrating a preprocessing method of a credit evaluation model operating method according to some embodiments of the present invention.

FIG. 9 is a flowchart of a credit rating method using a second-step logistic regression model in the credit evaluation model operating method according to some embodiments of the present invention.

FIG. 10 is a table showing a difference in performance index between a credit evaluation model according to some embodiments of the present invention and a conventional credit evaluation model.

FIG. 11 is a diagram illustrating hardware implementation of a system that performs a credit evaluation model operating method according to some embodiments of the present invention.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

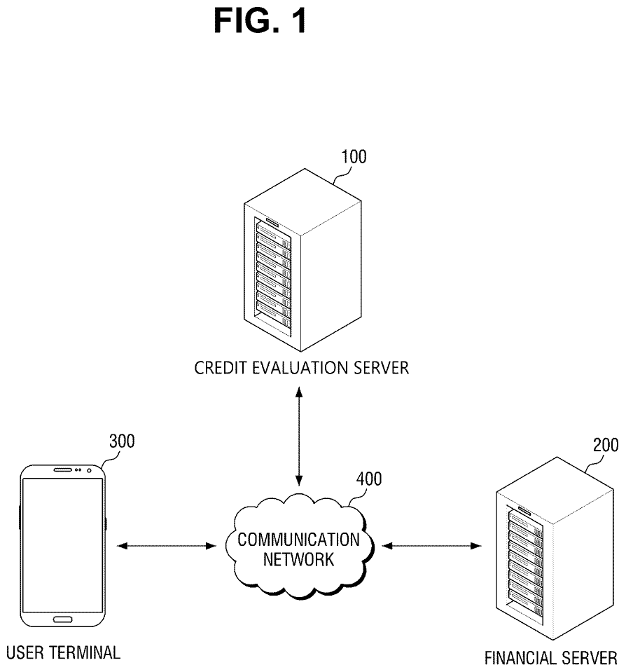

Hereinafter, a credit evaluation model operating system and a credit evaluation model operating method according to some embodiments of the present invention are described with reference to FIGS. 1 to 11.

FIG. 1 is a diagram illustrating a credit evaluation model operating system according to some embodiments of the present invention.

Referring to FIG. 1, the credit evaluation model operating system may include a credit evaluation server 100, a financial server 200, a user terminal 300, and a communication network 400.

A user may use various financial services through the financial server 200. At this time, the user may access the financial server 200 through the user terminal 300, and a financial service requested by the user terminal 300 and data provided by the financial server 200 may be stored in the financial server 200 in the form of log data.

The financial server 200 and the user terminal 300 may be implemented as a server-client system. The financial server 200 may store and manage a user's subscription name information, authentication information, and activity information in each customer account, and may provide various services related to finance through a financial application installed in the user terminal 300.

At this time, the financial application may be a dedicated application for providing financial services or a web browsing application. Here, the dedicated application may be an application built into the user terminal 300 or an application downloaded from an application distribution server and installed on the user terminal 300.

Meanwhile, the financial server 200 may be required to check a customer's creditability before providing a specific financial service requested by the user. At this time, the financial server 200 may transmit a trace (that is, log data) left by the user while using the financial application to the credit evaluation server 100, and the credit evaluation server 100 may predict a user's creditability based on the received log data of the user and transmit a result of the prediction to the financial server 200.

The credit evaluation server 100 may rate or predict a user's creditability by using a pre-trained credit evaluation model. The credit evaluation server 100 may use the credit evaluation model pre-trained based on data on a plurality of users.

The credit evaluation server 100 may operate the credit evaluation model by using as many variables as possible to increase accuracy of the credit evaluation model. The credit evaluation server 100 may operate the credit evaluation model by using logistic regression analysis.

However, in the case of a logistic regression model, only a maximum of about 10 explanatory variables may be used in the model, and thereby, when variables in a new information domain are discovered, previously used variables may not be used due to limitations of linear independence, and accordingly, there may be limits to improving model performance.

Accordingly, the credit evaluation server 100 of the present invention constructs a credit evaluation model by using a two-step logistic regression model, thereby improving the performance of the credit evaluation model by using more explanatory variables, and at the same time ensuring perfect explanatory power. Detailed descriptions of the credit evaluation model operating method of the present invention, which is performed by the credit evaluation server 100, are made below.

Meanwhile, the user terminal 300 refers to a communication terminal capable of operating multiple applications in a wired or wireless communication environment. Although FIG. 1 illustrates that the user terminal 300 is a smart phone which is a type of portable terminal, the present invention is not limited thereto, and the user terminal 300 may be applied without limitation to a device that may operate a financial application or SNS application as described above. For example, the user terminal 300 may include various types of electronic devices, such as a personal computer (PC), a laptop, a tablet, a mobile phone, a smartphone, and a wearable device (for example, a watch-type terminal).

Additionally, the user terminal 300 may include an input unit that receives a customer's input, a display unit that displays visual information, a communication unit that transmits and receives signals to and from the outside, a camera unit that images the customer's face, a microphone unit that converts the customer's voice into digital data, and a control unit that processes data, controls each unit in the user terminal 300, and controls data transmission/reception between units. Hereinafter, commands that the control unit executes in the user terminal 300 according to a customer's commands are collectively referred to as being performed by the user terminal 300.

Meanwhile, the communication network 400 serves to connect the credit evaluation server 100, the user terminal 300, and the financial server 200. That is, the communication network 400 refers to a communication network that provides a connection path such that the user terminal 300 may transmit and receive data after being connected to the credit evaluation server 100 and the financial server 200. The communication network 400 may include, for example, wired networks such as LANs (Local Area Networks), WANs (Wide Area Networks), MANs (Metropolitan Area Networks), and ISDNs (Integrated Service Digital Networks), or wireless networks such as wireless LANs, CDMA, Bluetooth, and satellite communications, but the scope of the present invention is not limited thereto.

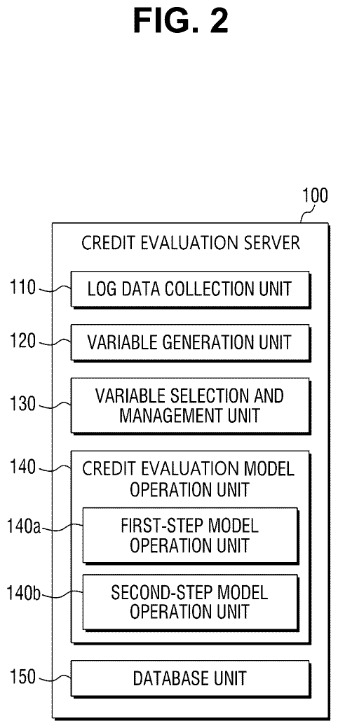

FIG. 2 is a diagram illustrating the credit evaluation server of FIG. 1.

Referring to FIG. 2, the credit evaluation server 100 of the present invention includes a log data collection unit 110, a variable generation unit 120, a variable selection and management unit 130, a credit evaluation model operation unit 140, and a database unit 150.

The log data collection unit 110 performs a function of collecting log files (that is, log data) for data exchanged between the financial server 200 and the user terminal 300.

Here, the log data may include a financial service requested by a user through a financial application and data provided to the user in response thereto. The log data may be stored in the form of an event code and include multiple event codes. The log data collection unit 110 may receive log data stored in a user account from the financial server 200 or collect log data by monitoring a data flow between the user terminal 300 and the financial server 200.

The variable generation unit 120 may select basic variable items based on the received log data and generate candidate variables by calculating the frequency of the basic variable items within the log data.

Specifically, the variable generation unit 120 may select a plurality of variable basic items corresponding to event codes by classifying the event codes included in the log data by using predetermined categories and features.

Also, the variable generation unit 120 may generate a plurality of candidate variables by calculating term frequency (TF) and term frequency-inverse document frequency (TF-IDF) for a plurality of selected basic variable items. A detailed calculation method of the term frequency (TF) and term frequency-inverse document frequency (TF-IDF) is described below.

Also, the variable generation unit 120 may generate a plurality of first derived variables by applying different time windows and different calculation methods to the plurality of candidate variables. A detailed description of the method of generating the first derived variable is also be made below.

The variable selection and management unit 130 compares the first derived variable generated by the variable generation unit 120 with a predetermined standard value and selects important variables based thereon. Also, the variable selection and management unit 130 may store and manage the selected important variables by clustering (or grouping) the selected important variables for each information domain (F). At this time, the important variables may be used as input variables of the first-step logistic regression model.

The credit evaluation model operation unit 140 includes a first-step model operation unit 140a and a second-step model operation unit 140b that may operate a two-stage logistic regression analysis model.

The first-step model operation unit 140a may be an operating entity that operates a first logistic regression analysis model. The first-step model operation unit 140a may operate the first-step logistic regression analysis model by using an important variable in the same information domain (F) as an input variable and using good/bad information on credit (that is, whether a user's credit is defaulted) as a dependent variable. A detailed description of the input variable and dependent variable applied to the first-step logistic regression model and an equation representing a relationship therebetween is made below.

The second-step model operation unit 140b may be an operating entity that operates a second logistic regression analysis model. The second-step model operation unit 140b may operate the second-step logistic regression model by using an output value of a first-step model (good/bad probability of a first final variable) as an input variable and using good/bad information on credit (that is, whether a user's credit is defaulted) as a dependent variable. A detailed description of the input variable and dependent variable applied to the two-step logistic regression model and an equation representing a relationship therebetween is made below.

The database unit 150 may store and manage information on various variables applied to each logistic regression analysis model operated by the credit evaluation model operation unit 140. Also, the database unit 150 may store and manage log data of various users for training the credit evaluation model operation unit 140 or executing a credit rating, as well as intermediate data calculated in a pre-processing process of the log data. However, these are only a few examples and the present invention is not limited thereto.

Hereinafter, a credit evaluation model operating method, which is performed in the credit evaluation server 100, according to some embodiments of the present invention is described in detail.

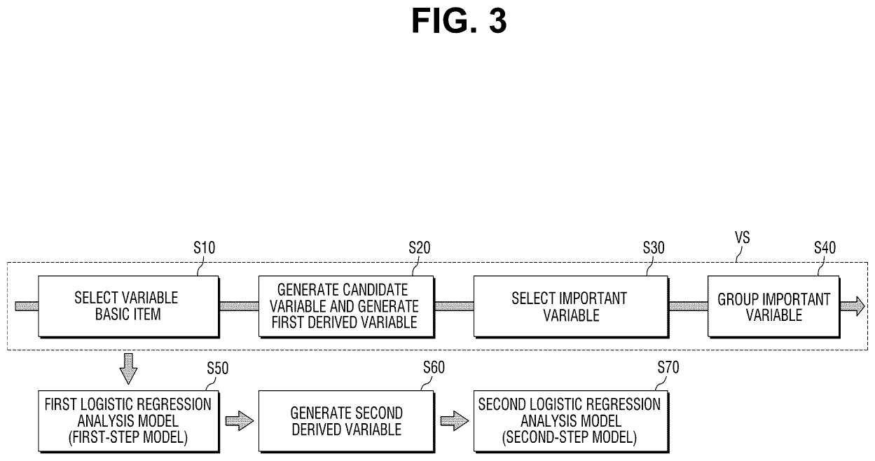

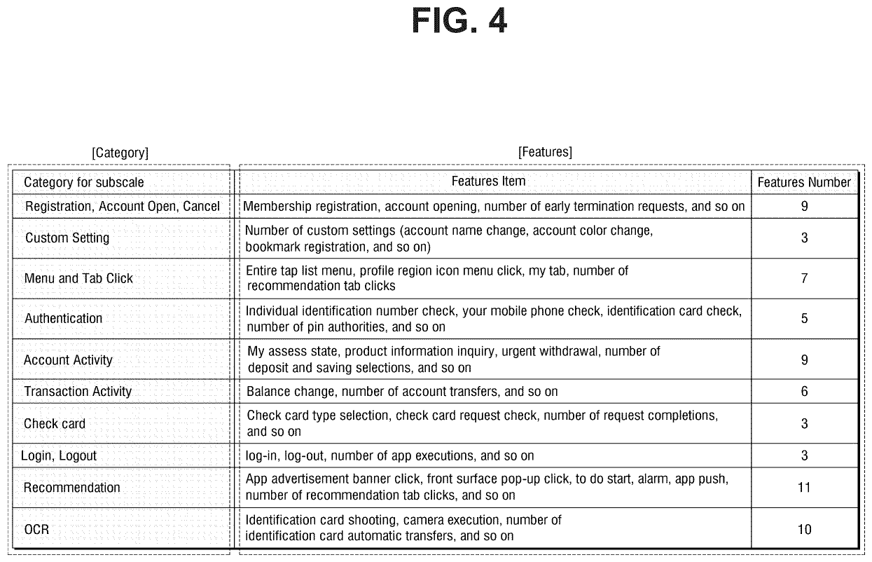

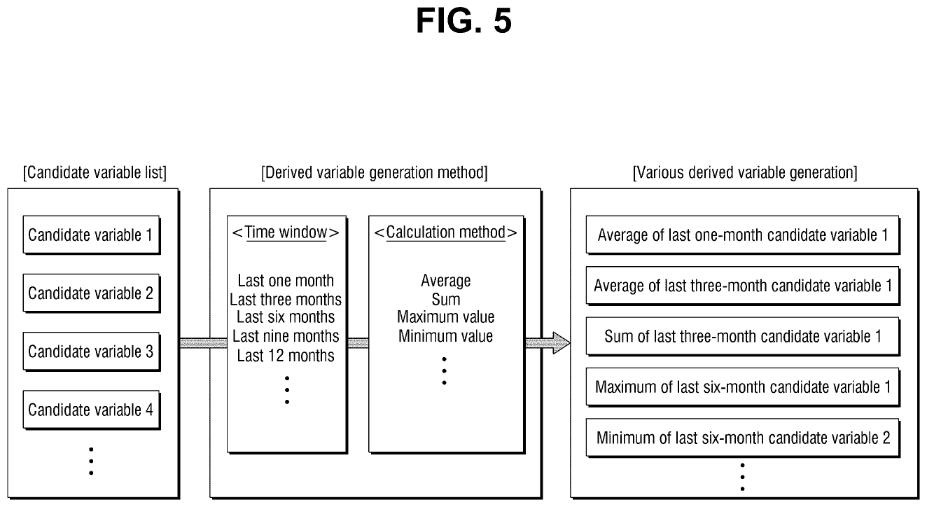

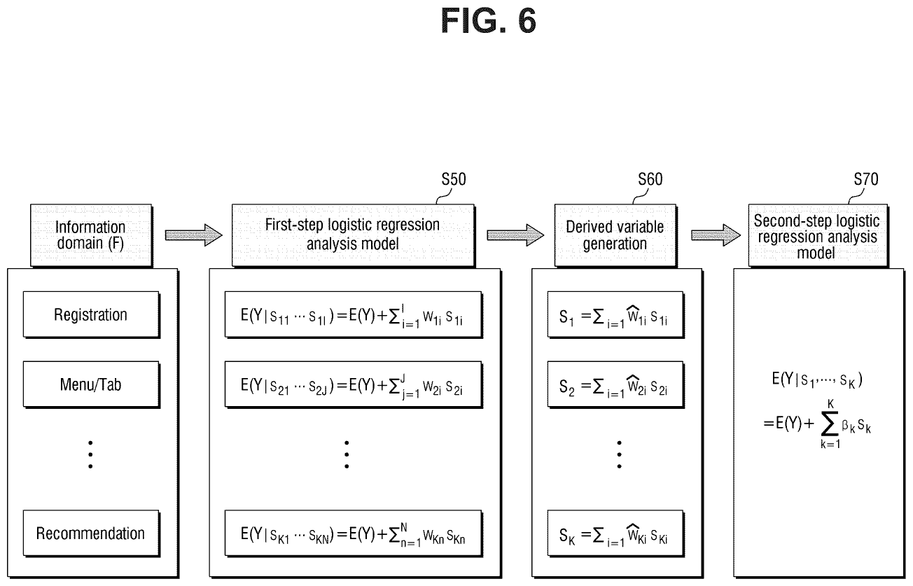

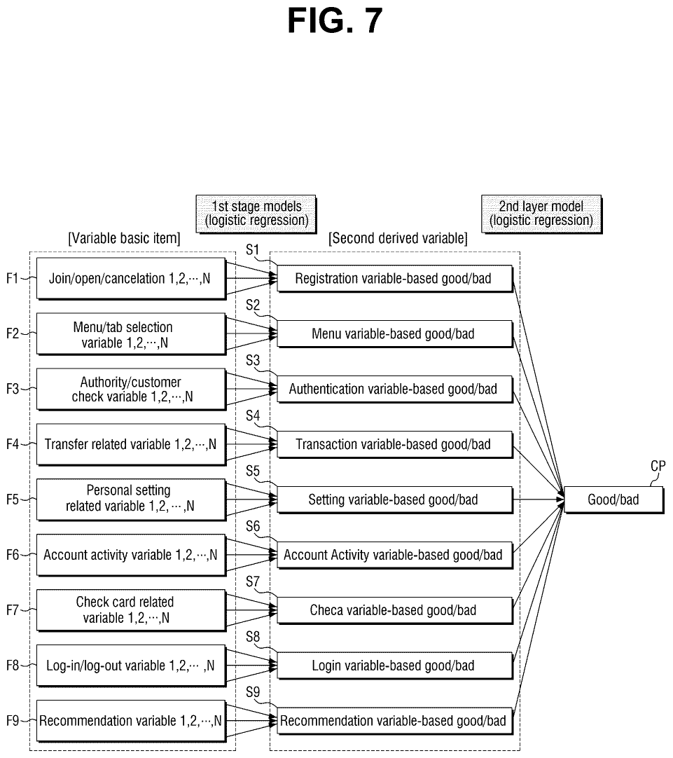

FIG. 3 is a block diagram illustrating a credit evaluation model operating method according to some embodiments of the present invention. FIG. 4 is a table illustrating an example of categories and features for selecting basic variable items of FIG. 3. FIG. 5 is a block diagram illustrating a method of generating a first derived variable of FIG. 3. FIG. 6 is a block diagram illustrating a relationship between a two-step logistic regression model used in step S50 to step S70 of FIG. 3. FIG. 7 is a block diagram illustrating an example of variable items for rating a user's credit by using a two-step logistic regression model.

First, referring to FIG. 3, in the credit evaluation model operating method according to some embodiments of the present invention, the credit evaluation server 100 may perform a pre-processing process (VS) of selecting variables input to a credit evaluation model.

Specifically, the credit evaluation server 100 selects a basic variable item (S10). At this time, the ‘basic variable item’ is selected based on the record of data (hereinafter referred to as log-data) exchanged between the financial server 200 and the user terminal 300. That is, the credit evaluation server 100 may select basic variable items by using log data received from the financial server 200.

The log data includes data related to various actions performed by an application installed to the user terminal 300 by a user and may be used as basic data to capture a user's behavioral characteristics. At this time, the financial server 200 may classify event codes included in the log data by using a predetermined category, and classify the event codes belonging to a corresponding category again by using a plurality of predetermined features.

For example, referring to FIG. 4, the event codes included in the log data may be classified as categories of Registration, Custom Setting. Menu Click, Authentication, Account Activity, Transaction Activity, Check Card, Login/Logout, Recommendation, and OCR (Optical character recognition). Also, the event codes belonging to each category may be classified as a plurality of features and stored. For example, event codes belonging to an ‘account registration’ category may be classified as feature items (hereinafter referred to as features), such as membership registration, account opening, early termination, and recommender registration, and stored.

At this time, log data may be stored in the financial server 200, and the credit evaluation server 100 may receive the log data from the financial server 200 and use the log data to select basic variable items. Also, the log data may be stored in the financial server 200 and the credit evaluation server 100 and used separately for each customer.

The credit evaluation server 100 regards a set of event codes included in the log data as a type of document and assumes that frequently appearing event codes represent characteristics of a customer behavior. Subsequently, the credit evaluation server 100 may assign information on the category and feature to which the event code belongs to the event code in order to classify characteristics of the customer behavior in detail and use the information. The credit evaluation server 100 may select a plurality of variable basic items corresponding to respective event codes by classifying the plurality of event codes included in the log data by using categories and features.

Additionally, information on categories and features for event codes may also be pre-assigned to the financial server 200 and provided to the credit evaluation server 100.

Subsequently, the credit evaluation server 100 generates a plurality of candidate variables (hereinafter, CV) by calculating the frequency (Frequency) of each of a plurality of selected variable basic items or specific event codes and generates a first derived variable by using a plurality of calculation methods for a predetermined period for a generated candidate variable (CV) (S20).

Here, the candidate variable (CV) means a ‘term frequency (hereinafter, TF)’ and an ‘inverse document frequency (hereinafter, IDF)’ of each event code included in the log data or a variable basic item to which the event code belongs and means a ‘term frequency-inverse document frequency (hereinafter, TF-IDF) obtained by multiplying the term frequency (TF) by the inverse document frequency (IDF).

Specifically, the term frequency (TF) refers to a frequency by which a specific word is repeated in a document (or log data). The term frequency (TF) may be calculated in various ways by using simple frequency, Boolean frequency, increase frequency, and log frequency. At this time, the simple frequency means a value calculated by counting the number of specific event codes. The Boolean frequency means a value calculated as ‘1’ when a specific event code appears more than once, and as ‘0’ otherwise. The increase frequency means a value obtained by dividing the simple frequency of a specific event code by a frequency value of the most frequent event code. The log frequency means a value obtained by adding 1 to the simple frequency of a specific event code and then taking a natural logarithm.

In the present invention, a method of calculating the term frequency (TF) is not limited to the four methods described above, and for the sake of convenience of description, calculating four term frequencies are used as an example below.

Meanwhile, the inverse document frequency (IDF) may be defined by <Equation 1> below.

$$I D F ( t ) = log [ n / \{ 1 + d f ( t ) \} ] \qquad < Equation 1 >$$

where, t means a specific event code, n means the total number of users (for example, customers), and df(t) means the number of users where the specific event code t occurs.

That is, according to <Equation 1> above, the inverse document frequency (IDF) means a value indicating how commonly one word appears throughout the document (or log data). That is, the inverse document frequency (IDF) means how commonly one event code (or variable base item) appears in documents (or log data).

Subsequently, the credit evaluation server 100 may calculate the term frequency (TF) for each event code (or variable base item) and then multiply or does not multiply the inverse document frequency (IDF) to the term frequency (TF), and thereby, one or more candidate variables (CV) may be generated. For example, eight candidate variables (CV) may be generated by calculating the term frequency (TF) by four methods and multiplying or not multiplying by the inverse document frequency (IDF).

As the record of a specific event code (or variable base item) appears more frequently in a small number of users, or as the event code appears less frequently in all customers, a TF-IDF value increases. Therefore, event codes that commonly occur in many customers have small TF-IDF values, and as a result, it is difficult for the event codes to be adopted as model variables.

Subsequently, the credit evaluation server 100 generates a plurality of first derived variable by applying various calculation methods for a predetermined period to a plurality of generated candidate variables (CV).

Specifically, referring to FIG. 5, the credit evaluation server 100 may generate a plurality of first derived variables by selecting one of a plurality of time windows and one of a plurality of calculation methods for a plurality of candidate variables (CV).

For example, the plurality of time windows may include the last one month, the last three months, the last six months, the last nine months, and the last 12 months, and the plurality of calculation methods may include an average, a sum, a maximum value, and a minimum value of selected time windows of a specific candidate variable. However, in the present invention, the time windows are not limited to the above description, and starting and ending time points of the time windows may be set to a predetermined period and used. The plurality of calculation methods are also not limited to the above description.

That is, the credit evaluation server 100 may generate various first derived variables through a combination of the plurality of time windows and the plurality of calculation methods previously determined for the plurality of candidate variables (CV). Arithmetically, the first derived variable may be calculated as many times as the product of the number of time windows and the number of calculation methods and used.

Subsequently, referring again to FIG. 3, the credit evaluation server 100 selects a first derived variable that satisfies a preset reference among the plurality of generated first derived variables as an important variable (S30). At this time, the credit evaluation server 100 may use 1) P-value (probability value) indicating statistical significance, and 2) information value (IV value) as a method of selecting an important variable.

In general, the P value means a probability that statistic value is greater than the actually observed value, assuming that a specific hypothesis is correct. For example, the P value may mean a probability in which a statistic value, that is ‘equal or more extreme’ than a statistic value actually observed from a sample, is observed under the premise that a null hypothesis is correct. Because detailed information on the P value is already disclosed, a detailed description thereof is omitted below.

In the present invention, the P value is used as a reference for statistical significance. The credit evaluation server 100 may perform univariate logistic regression analysis with the dependent variable (for example, default of a user's credit) on all of first derived variables and may select a first derived variable with a P value less than 0.05, which indicates the statistical significance of the estimated coefficient, as important variables. Here, the P value of 0.05 means that the estimated coefficient is statistically significant when a significance level is 5%.

Meanwhile, the IV value may be calculated by <Equation 2> below.

$$I V = {\sum }_{i} ( \% of Goods - \% of Bads ) \times W O {E}_{i} \qquad < Equation 2 >$$

Where, ‘% of Goods’ means the entire ratio of a group evaluated as good, ‘% of Bads’ means the entire ratio of a group evaluated as bad, and WOE (Weights of Evidence (hereinafter. WOE) is defined by <Equation 3> below for each variable i.

$$W O {E}_{i} = {ln ( \frac{\% of Goods}{\% of Bads} )}_{i} \qquad < Equation 3 >$$

At this time, WOE means a natural logarithm of a ratio of the group evaluated as good compared to a ratio of the group evaluated as bad.

Here, a larger positive value of the WOE value may mean a lower risk, and a larger negative value of the WOE may mean a higher risk. Also, in the present invention, when the IV value is less than 0.02, it can be determined that the explanatory power for a dependent variable (for example, whether a user's credit is defaulted) is insufficient.

Again in step S30, the credit evaluation server 100 calculates P values and IV values of the plurality of first derived variables in order to select important variables. For example, the credit evaluation server 100 may determine whether the calculated P value is less than 0.05 and whether the IV value is 0.02 or more. However, this is only an example and the present invention is not limited thereto.

Subsequently, the credit evaluation server 100 may select the first derived variable having a P value of less than 0.05 or an IV value of 0.02 or more as an important variable and may use the selected first derived variable for a first-step logistic regression model.

Subsequently, the credit evaluation server 100 may cluster (that is, group) of variables belonging to the same (or similar) information domain (F) among the selected important variables (S40).

At this time, the credit evaluation server 100 may perform the clustering by using a heuristic method by an expert or a data-driven (for example, k-means clustering, or so on) method. Since the heuristic method and data driven method are already publicized, detailed descriptions thereof are omitted below. Also, the credit evaluation server 100 may perform clustering for each filtration (hereinafter, F) by using a category and feature to which a candidate variable that is the basis of the first derived variable belongs. However, this is only an example of clustering, and the present invention is not limited thereto.

Additionally, it is obvious to those skilled in the art that step S40 may be omitted in the present invention. However, for the sake of convenience of description, clustering is used as an example.

Subsequently, the credit evaluation server 100 applies the important variables clustered for each information domain (F) to the first-step logistic regression model (hereinafter, a first-step model) (S50).

At this time, the first-step model means a credit evaluation model that uses an important variable in the same information domain (F) as an input variable and uses good/bad information on credit (that is, whether a user's credit is defaulted) as dependent variable. A general logistic regression model may be employed in the first-step model.

Specifically, in the present invention, logistic regression analysis operates based on following assumptions.

(Assumption 1) Variables generated from a specific information domain (F) are used as weighted values by identifying information fₖ on prediction related to bankruptcy. In order to implement this, an estimation coefficient obtained by the first-step model may be used as a weighted value.

(Assumption 2) Observation data ski consists of information fₖᵢ on prediction related to bankruptcy and other noise eᵢ.

$${S}_{ki} = {f}_{ki} + {e}_{ki} where {e}_{ki} \sim iid ( {μ}_{k} , {σ}_{k}^{2} ) \qquad < Equation 4 >$$

Where, k means an information domain, and i means an individual variable. Ski means a variable value of a variable i belonging to the information domain k. idd (independently and identically distributed) means ‘independently and homogeneously distributed’, and a where clause means that a value of noise eₖᵢ is independently and homogeneously generated from a random distribution with an average uₖ and a variance σₖ².

Specifically, in the first-step model, when a conditional default prediction model is generated by using observation data (that is, observed variables or explanatory variables) sₖᵢ belonging to the information domain (F), a result is represented by <Equation 5> below.

$$E ( Y \vert {s}_{k 1} , … , {s}_{ki} ) = E ( Y ) + {\sum }_{i = 1}^{I} {w}_{ki} {s}_{ki} where , {w}_{ki} = \frac{Cov ( Y , {s}_{ki} )}{Var ( {s}_{ki} )} \qquad < Equation 5 >$$

Where, E( ) means an expectation operator, Y means a dependent variable (that is, whether a user's credit is defaulted), X (that is,) means an explanatory variable (or an input variable), E(Y|X) means that Y is conditionally predicted by using X, E(Y) means an unconditional expectation value when the information X is not used, Cov is covariance and means a value obtained by measuring common movements of two variables, and Var is a variance and means an average of values obtained by squaring a difference from an average of variables.

Also, a weighted value wₖᵢ means a regression estimation coefficient (hereinafter, an estimation coefficient) and means the explanatory power of a signal (sₖᵢ; an explanatory variable or observation variable) on a change in the dependent variable Y. The weight wₖᵢ may be represented by <Equation 6>.

$${w}_{ki} = \frac{Cov ( Y , {s}_{ki} )}{Var ( {s}_{ki} )} = \frac{Cov ( Y , {f}_{ki} + {e}_{ki} )}{Var ( {f}_{ki} + {e}_{ki} )} = \frac{Cov ( Y , {f}_{ki} ) + Cov ( Y , {e}_{ki} )}{Var ( {f}_{ki} ) + Var ( {e}_{ki} )} = \frac{Cov ( Y , {f}_{ki} )}{Var ( {f}_{k} ) + {σ}_{k}^{2}} \qquad < Equation 6 >$$

Where, the larger the variance σₖ² of a noise included in a signal (; explanatory variable or observation variable) (that is, the lower the reliability of the signal), the smaller the weighted value wₖᵢ of the signal.

In summary, the weighted value wₖᵢ of the first-step model means a value obtained by dividing a covariance between the explanatory variable X and the dependent variable Y by a variance of the explanatory variable. At this time, the weight wₖᵢ is the same as the definition of an estimation coefficient when performing regression analysis.

Subsequently, a final variable to be applied to the first-step model may be selected through a step-wise method. At this time, the step-wise selection method means a method of performing a process of adding and removing variables to a model and selecting variables to increase an explanatory power of the model while performing the process sequentially for all variables.

Referring to FIG. 6, the dependent variable Y applied to the first-step model indicates whether a user's credit is defaulted, and the explanatory variable X (that is, the signal) corresponds to an important variable selected in step S30.

For example, a first-step model performs a step-wise method for one or more important variables of which information domain (F) is a registration category. the credit evaluation server 100 selects important variables having relatively high weighted values wₖᵢ among respective important variables belonging to a specific category as final variables and excludes important variables having relatively low weighted values wₖᵢ from the final variables.

Additionally, in order to select final variables, the first-step model may use not only the step-wise selection method but also the feedforward selection or backward elimination method. Here, the feedforward selection method means a method of selecting whether or not to add variables by adding the variables and comparing performance indexes, and the backward elimination method is an opposite of the forward selection method and means a method of comparing performance indexes while removing variables.

Subsequently, the credit evaluation server 100 generates a value obtained by multiplying the selected final variables (that is, selected important variables/signals sₖᵢ) by the estimated regression coefficients (that is, weighted values wₖᵢ) and by adding together as second derived variables (S1, S2, . . . , Sk) to be used as explanatory variables for the second-step model (that is, second-step logistic regression model) (S60). Here, the second derived variable represents a good/bad probability of the final variables classified for each information domain (F).

Subsequently, the credit evaluation server 100 applies the generated second derived variable to a second-step logistic regression model (hereinafter, a second-step model) (S70).

At this time, the second-step model means a credit evaluation model that uses an output value of the first-step model (that is, second derived variable; good/bad probability of the final variable) as an input variable and uses good/bad information on a user's credit (that is, whether a user's credit is defaulted) as a dependent variable. Likewise, a general logistic regression model may be employed in the second-step model.

Specifically, a conditional default prediction model generated by using the second derived variables (S1, S2, . . . , Sk) from the second-step model is represented by <Equation 7> below.

$$E ( Y \vert {S}_{1} , … , {S}_{k} ) = E ( Y ) + {\sum }_{k = 1}^{K} {β}_{k} {S}_{k} where , {β}_{k} = \frac{Cov ( Y , {S}_{k} )}{Var ( {S}_{k} )} \qquad < Equation 7 >$$

Where, E( ) means an expectation operator, Y means a dependent variable, X (that is,) means an explanatory variable (or an input variable), E(Y|X) means that Y is conditionally predicted by using X, E(Y) means an unconditional expectation value when the information X is not used, Cov is covariance and means a value obtained by measuring common movements of two variables, and Var is a variance and means an average of values obtained by squaring a difference from an average of variables. Also, a weighted value βₖ means a regression estimation coefficient (hereinafter. an estimation coefficient) and means the explanatory power of a signal (Sₖ; an explanatory variable, an input variable, or an observation variable) on a change in the dependent variable Y. The weighted value βₖ may be expressed in substantially the same way as the <Equation 6> described above, and a redundant description thereof is omitted.

Also, like the first-step model, the second-step model may select final variables to be applied to the second-step model through a step-wise method.

Subsequently, the credit evaluation server 100 repeatedly performs step $10 to step S70 described above based on log data for a plurality of users in order to finally select optimal final variables to be applied to the first-step model and the second-step model.

Subsequently, the credit evaluation server 100 may generate a credit rating of a new user by using the first-step model (that is, a trained first-step model) in which the final variable is specified and a second-step model (that is, a trained second-step model) in which the final variable is specified through the above-described steps.

For example, referring to FIG. 7, the credit evaluation server 100 selects variable basic items by using event codes included in log data with a predetermined category and a plurality of predetermined features, and clusters the selected variable basic items for each information domain (F) (for example, F1 to F9).

Subsequently, the credit evaluation server 100 calculates second derived variables (for example, S1 to S9) by multiplying the final variable (that is, selected important variable/signal) classified for each information domain (F) by the pre-estimated regression coefficient (that is, the weighted value wₖᵢ) of the final variable by using the trained first-step model.

Subsequently, the credit evaluation server 100 calculate a probability of default as a result of a user's good or bad credit by using the trained second-step model. At this time, the result may be output as a value between 0 and 1, and the credit evaluation server 100 may determine the degree of good or bad credit of a user based on the calculated result.

Subsequently, a resultant value calculated by the credit evaluation server 100 may be transmitted to the financial server 200 and used to determine whether to provide a financial service according to a user's creditability.

Hereinafter, a credit evaluation model operating method according to some embodiments of the present invention is described.

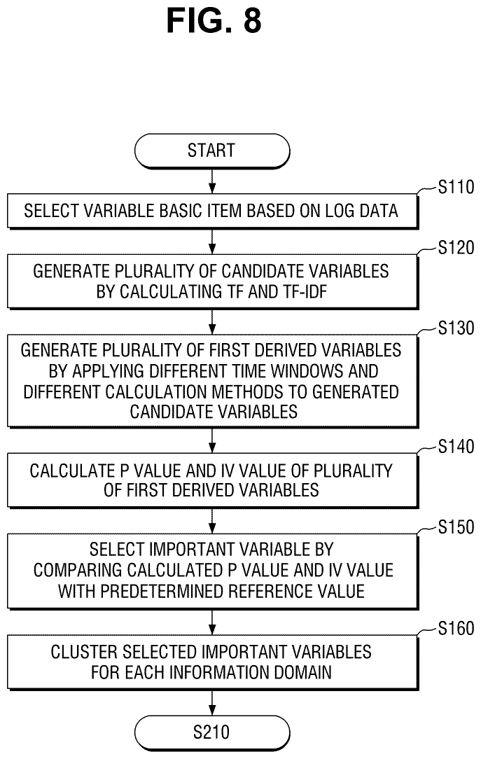

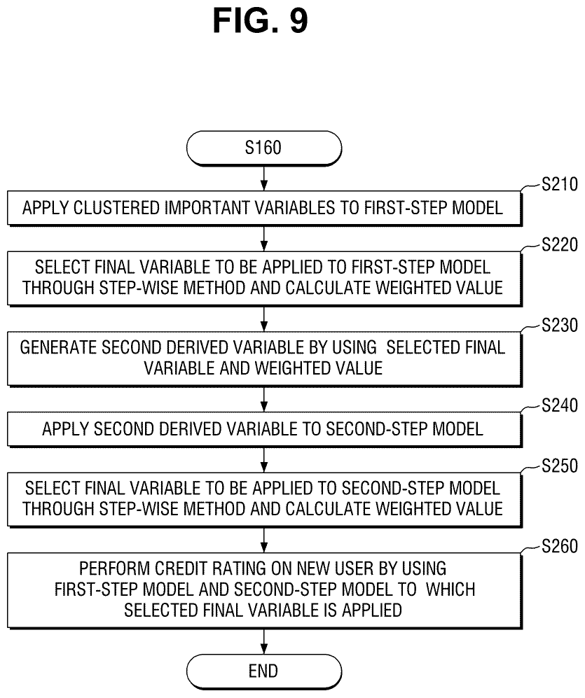

FIG. 8 is a flowchart illustrating a preprocessing method of a credit evaluation model operating method according to some embodiments of the present invention. FIG. 9 is a flowchart of a credit rating method using a second-step logistic regression model in the credit evaluation model operating method according to some embodiments of the present invention.

In the credit evaluation model operating method according to some embodiments of the present invention, each step may be distributed to the credit evaluation server 100 and the financial server 200 and implemented in a complementary manner, or may be implemented only by the credit evaluation server 100. However, hereinafter, for the sake of convenience of description, what is implemented by the credit evaluation server 100 is described as an example. Also, hereinafter, redundant description of the above description is omitted, and a difference therebetween is mainly described.

Referring to FIG. 8, the credit evaluation server 100 first selects a basic variable item based on log data received from the financial server 200 (S110). The credit evaluation server 100 may select a plurality of basic variable items corresponding to event codes by classifying the event codes included in log data by using predetermined categories and features.

Subsequently, the credit evaluation server 100 generates a plurality of candidate variables by calculating a term frequency (TF) and a term frequency-inverse document frequency (TF-IDF) for the plurality of selected basic variable items (S120).

For example, the term frequency (TF) may be calculated by using four methods including simple frequency, Boolean frequency, incremental frequency, and log frequency, and the inverse document frequency (IDF) is a value indicating whether a specific variable basic item commonly appears in log data and may be calculated by using <Equation 1> described above. The term frequency-inverse document frequency (TF-IDF) may be generated by multiplying four term frequencies (TF) by the inverse document frequency (IDF). Therethrough, eight candidate variables (CV) including four term frequencies (TF) and four term frequencies-inverse document frequencies (TF-IDF) may be generated. However, this is only an example, and the number of term frequencies (TF) and the number of candidate variables (CV) may also be modified differently to be implemented.

Subsequently, the credit evaluation server 100 generates a plurality of first derived variables by applying different time windows and different calculation methods respectively to the plurality of generated candidate variables (CV) (S130).

For example, the time window may include the last 1 month, the last three months, the last six months, the last nine months, and the last 12 months, and the calculation method may include an average, a sum, a maximum value, and a minimum value for the selected time window of a specific candidate variable. Accordingly, the credit evaluation server 100 may generate a plurality of first derived variables through a combination of different time windows and different calculation methods for each candidate variable (CV).

Subsequently, the credit evaluation server 100 calculates a P value and an IV value of the plurality of first derived variables (S140). Here, the P value means statistical significance indicating statistical significance between the dependent variable and estimated coefficient derived by performing univariate logistic regression analysis on the first derived variable. The IV value may be calculated by using <Equation 2> described above.

Subsequently, the credit evaluation server 100 selects an important variable by comparing the calculated P value and IV value with a predetermined reference value (S150). For example, the credit evaluation server 100 may select the important variables by determining whether the calculated P value is less than 0.05 and whether the IV value is more than or equal to 0.02. At this time, the credit evaluation server 100 may select important variables by comparing only the P value or the IV value with a predetermined reference value, and determines the first derived variable that satisfies the predetermined condition as the important variables by comparing both the P value and the IV value with the predetermined reference value.

Subsequently, the credit evaluation server 100 may cluster the selected important variables for each information domain (F) (S160). At this time, the credit evaluation server 100 may perform clustering for each information domain (F) by using a heuristic method by an expert or a data-driven (for example, k-means clustering or so on) method. Also, the credit evaluation server 100 may perform clustering for each information domain (F) by using a category and feature to which candidate variables that are the basis of the first derived variable belongs.

The important variables clustered for each information domain (F) may be used as input variables for a first-step logistic regression model (that is, first-step model).

Subsequently, referring to FIG. 9, the credit evaluation server 100 applies important variables clustered for each information domain (F) to the first-step model (S210). At this time, the first-step model means a credit evaluation model that uses important variables in the same information domain (F) as input variables and uses good/bad information on credit (that is, whether a user's credit is defaulted) as a dependent variable. A general logistic regression model may be employed in the first-step model.

Subsequently, the credit evaluation server 100 selects a first final variable to be applied to the first-step model through a step-wise method and calculates a weighted value for the selected first final variable (S220). At this time, the credit evaluation server 100 may calculate a weighted value wₖᵢ for each important variable belonging to a specific category, select important variables having a relatively high weighted value wₖᵢ as the first final variable, and exclude important variables having a relatively low weighted value wₖᵢ from the first final variable. The weighted value wₖᵢ for important variables may be calculated by using <Equation 6>.

Subsequently, the credit evaluation server 100 generates a second derived variable by using the selected first final variable and weighted value (S230). Here, the second derived variable is obtained by multiplying the selected first final variable by a weighted value therefor. The second derived variable represents a credit default probability (that is, whether a user's credit is defaulted) of the first final variables classified for each information domain (F).

Subsequently, the credit evaluation server 100 applies the second derived variable to a second-step logistic regression model (hereinafter, a second-step model) (S240). At this time, the second-step model means a credit evaluation model that uses an output value of the first-step model (that is, second derived variable; good/bad probability of the first final variable) as an input variable and uses good/bad information on credit (that is, whether a user's credit is defaulted) as a dependent variable. Likewise, a general logistic regression model may be employed in the second-step model.

Subsequently, the credit evaluation server 100 selects a second final variable to be applied to the second-step model through a step-wise method and calculates a weighted value for the selected second final variable (S250).

Subsequently, the credit evaluation server 100 performs a credit rating on a new user by using the first-step model and the second-step model to which the selected second final variable is applied (S260).

At this time, the credit evaluation server 100 may receive log data on a new user from the financial server 200, extract a basic variable item corresponding to the second final variable selected from the received log data, and then calculate whether a user's credit is good or bad by using a pre-generated first-step model and a second-step model. Therethrough, the credit evaluation server 100 may perform a credit rating on the new user.

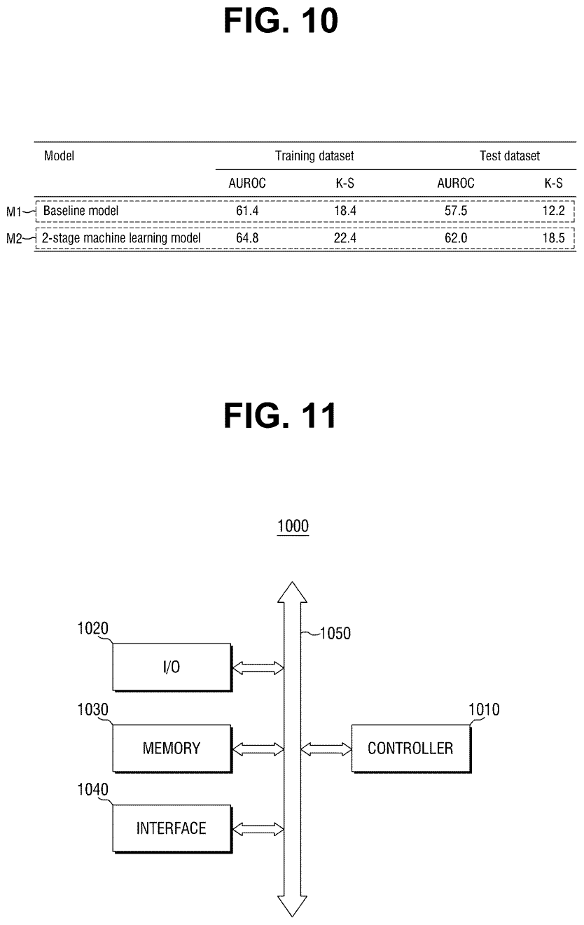

FIG. 10 is a table showing a difference in performance index between a credit evaluation model according to some embodiments of the present invention and a conventional credit evaluation model.

Referring to FIG. 10, the credit evaluation model composed of a second-step logistic regression model may evaluate reliability of the model by using a performance index of K-S statistic amount (Kolmogorov-Smirnov Statistics) and AUROC (Area Under the Receiver Operating Characteristics). Since the information on K-S statistics and AUROC has already been publicized, detailed description thereof is omitted here.

When a first-step credit evaluation model (that is, baseline model M1) that uses only a general first-step logistic regression or machine learning module receives a training dataset for deriving the final variables to be applied to the credit evaluation model, the AUROC was measured to be 61.4, and the K-S statistic was measured to be 18.4. Also, when a test dataset is input into the first-step credit evaluation model from which the final variable was derived, the AUROC was measured to be 57.5 and the K-S statistic was measured to be 12.2.

Meanwhile, when the second-step logistic regression model (that is, a second-step model M2) according to some embodiments of the present invention described above receives a training dataset, the AUROC is measured to be 64.8, and thus, a performance index is increased by about 5% compared to the baseline model M1, and the K-S statistic was measured to be 22.4, and thus, the performance index is increased by about 18% compared to the baseline model M1.

Also, when the second-step model M2 receives the test dataset, the AUROC was measured to be 62.0, and thus, the performance index is increased by about 7% compared to the baseline model M1, and the K-S statistic was measured to be 18.5, and thus, the performance index is increased by about 34% compared to the baseline model M1.

Therefore, it can be seen that a performance index of the credit evaluation model composed of a second-step logistic regression model according to some embodiments of the present invention is significantly increased compared to the conventional first-step credit evaluation model.

FIG. 11 is a diagram illustrating hardware implementation of a system that performs a credit evaluation model operating method according to some embodiments of the present invention.

Referring to FIG. 11, a credit evaluation server 100 that performs the credit evaluation model operating method according to some embodiments of the present invention may be implemented by an electronic device 1000. The electronic device 1000 may include a controller 1010, an input/output (I/O) device 1020, a memory device 1030, an interface 1040, and a bus 1050. The controller 1010, the input/output device 1020, the memory device 1030, and/or the interface 1040 may be coupled to each other through the bus 1050. At this time, the bus 1050 corresponds to a path through which data is moved.

Specifically, the controller 1010 may include at least one of a CPU (Central Processing Unit), an MPU (Micro Processor Unit), an MCU (Micro Controller Unit), a GPU (Graphic Processing Unit), a microprocessor, a digital signal processor, a microcontroller, an application processor (AP), and logic elements capable of performing functions similar thereto.

The input/output device 1020 may include at least one of a keypad, a keyboard, a touch screen, and a display device.

The memory device 1030 may store data and/or a computer program.

The interface 1040 may perform a function of transmitting data to or receiving data from a communication network. The interface 1040 may be wired or wireless. For example, the interface 1040 may include an antenna or a wired or wireless transceiver and may receive various types of data collected from the user terminal 300 or exchange data generated in the process of executing the computer program loaded in the memory device 1030 with the user terminal 300.

Meanwhile, although not illustrated, the memory device 1030 may be an operating memory for improving an operation of the controller 1010 and may further include high-speed DRAM and/or SRAM. The memory device 1030 may store a computer program or an application therein.

The credit evaluation server 100 and the financial server 200 according to embodiments of the present invention may each be a system formed by connecting a plurality of electronic devices 1000 to each other through a network. In this case, each module or combination of modules may be implemented as the electronic device 1000. However, this embodiment is not limited thereto.

Additionally, the credit evaluation server 100 may be implemented by at least one of a workstation, a data center, an Internet data center (IDC), a DAS (direct attached storage) system, a SAN (storage area network) system, a NAS (network attached storage) system, a RAID (redundant array of inexpensive disks, or redundant array of independent disks) system, and an EDMS (Electronic Document Management) system, but the present embodiment is not limited thereto.

Also, the credit evaluation server 100 may transmit data to the financial server 200 through a network. The network may include a network based on wired Internet technology, wireless Internet technology, or short-distance communication technology. The wired Internet technology may include at least one of, for example, a LAN (local area network) and a WAN (wide area network).

The wireless Internet technology may include at least one of, for example, WLAN (Wireless LAN), DMNA (Digital Living Network Alliance), Wibro (Wireless Broadband). Wimax (World Interoperability for Microwave Access), HSDPA (High Speed Downlink Packet Access), HSUPA (High Speed Uplink Packet Access), IEEE 802.16, LTE (Long Term Evolution), LTE-A (Long Term Evolution-Advanced), WMBS (Wireless Mobile Broadband Service). and 5G NR (New Radio) technology. However, the present embodiment is not limited thereto.

The short-range communication technology include at least one of, for example, Bluetooth, RFID (Radio Frequency Identification), IrDA (Infrared Data Association), UWB (Ultra-Wideband), ZigBee, and NFC (Near Field Communication), USC (Ultrasound Communication), VLC (Visible Light Communication), Wi-Fi, Wi-Fi Direct, and 5G NR (New Radio). However, the present embodiment is not limited thereto.

The credit evaluation server 100 that communicates through a network may comply with a technical standard and a standard communication method for mobile communication. For example, the standard communication method may include at least one of, for example, GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTEA (Long Term Evolution-Advanced), and 5G NR (New Radio). However, the present embodiment is not limited thereto.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

1. Method for operating a credit evaluation model performed by a credit evaluation server linked to a financial server, the method for operating the credit evaluation model comprising:
a step of receiving log data of a user and selecting basic variable items included in the log data;
a step of generating candidate variables by calculating a frequency of the basic variable items in the log data;
a step of generating a plurality of first derived variables by applying different time windows or different calculation methods to the candidate variables;
a step of selecting important variables by comparing values related to the plurality of first derived variables with a predetermined standard value;
a step of deriving a first-step model by using the important variables as input variables and using information on the user's credit as a dependent variable;
a step of selecting a first final variable to be applied to the first-step model among the important variables and calculating a first weighted value for the first final variable;
a step of generating a second derived variable by using the first final variable and the first weighted value;
a step of deriving a second-step model by using the second derived variable as an input variable and using information on the user's credit as a dependent variable; and
a step of selecting a second final variable to be applied to the second-step model from among the first derived variables and calculating a second weighted value for the second final variable.

2. The method for operating the credit evaluation model of claim 1, wherein
the step of selecting the variable basic items includes selecting the variable basic items corresponding to event codes by classifying the event codes included in the log data by using a predetermined category and classifying the event codes belonging to the category by using a plurality of predetermined features.

3. The method for operating the credit evaluation model of claim 1, wherein
the step of generating the candidate variables includes calculating a term frequency (TF) and a term frequency-inverse document frequency (TF-IDF) of the variable basic items and generating the candidate variables, and
the term frequency (TF) is calculated by using a simple frequency, a Boolean frequency, an incremental frequency, or a log frequency, and the term frequency-inverse document frequency (TF-IDF) is calculated by multiplying the term frequency (TF) by the term frequency-inverse document frequency (TF-IDF).

4. The method for operating the credit evaluation model of claim 1, wherein
the step of generating the plurality of first derived variables includes generating the first derived variables by using one of a plurality of time windows of different sizes and one of a plurality of calculation methods for the candidate variable,
the time windows are able to be set to different periods, and
the calculation methods include an average, a sum, a maximum value, and a minimum value.

5. The method for operating the credit evaluation model of claim 1, wherein
the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and
the IV value is derived by an <equation> below.
$$I V = {\sum }_{i} ( \% of Goods - \% of Bads ) \times W O {E}_{i} \qquad \text{<Equation>}$$
where, ‘% of Goods’ means an entire ratio of a group evaluated as good, ‘% of Bads’ means an entire ratio of a group evaluated as bad, and WOE (Weights of Evidence; hereinafter WOE) means a value obtained by performing a natural logarithm on a value of the ratio of the group evaluated as good compared to the ratio of the group evaluated as bad.

6. The method for operating the credit evaluation model of claim 1, further comprising:
a step of grouping variables belonging to a same information domain (F) for the selected important variables, and
wherein the step of deriving the first-step model includes selecting the first final variable targeting the important variables included in a certain information domain (F).

7. The method for operating the credit evaluation model of claim 1, wherein
the first-step model and the second-step model consist of a logistic regression model.

8. The method for operating the credit evaluation model of claim 7, wherein
the first-step model selects the first final variable to be applied to the first-step model from among the important variables by using a step-wise selection method, and
the second-step model selects the second final variable to be applied to the second-step model from among the second derived variables by using the step-wise selection method.

9. The method for operating the credit evaluation model of claim 1, further comprising:
a step of performing a credit rating of a new user based on log data of the new user by using the first-step model to which the first final variable is applied and the second-step model to which the second final variable is applied.

10. A credit rating model operating method performed by a credit evaluation server linked to a financial server, The method for operating the credit evaluation model comprising:
a step of receiving log data of a user and selecting a frequency of event codes included in the log data and important variables through at least one preprocessing process for the frequency;
a step of deriving a first-step logistic regression mode by using the important variables as input variables and using information on the user's credit as a dependent variable;
a step of selecting a first final variable to be applied to the first-step model among the important variables and calculating a first weighted value for the first final variable;
a step of generating a derived variable by using the first final variable and the first weighted value;
a step of deriving second-step logistic regression model by using the derived variable as an input variable and using information on the user's credit as a dependent variable; and
a step of selecting a second final variable to be applied to the second-step model from among the derived variables and calculating a second weighted value for the second final variable.

11. The method for operating the credit evaluation model of claim 10, wherein
the first-step model selects the first final variable to be applied to the first-step model from among the important variables by using a step-wise selection method, and
the second-step model selects the second final variable to be applied to the second-step model from among the second derived variables by using the step-wise selection method.

12. The method for operating the credit evaluation model of claim 10, wherein
the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and
the IV value is derived by an <equation> below.
$$I V = {\sum }_{i} ( \% of Goods - \% of Bads ) \times W O {E}_{i} \qquad < Equation >$$
where, ‘% of Goods’ means an entire ratio of a group evaluated as good, ‘% of Bads’ means an entire ratio of a group evaluated as bad, and WOE (Weights of Evidence; hereinafter WOE) means a natural logarithm of the group evaluated as good relative to the group evaluated as bad.

13. The method for operating the credit evaluation model of claim 10, further comprising:
a step of grouping variables belonging to a same information domain (F) for the selected important variables, and
wherein the step of deriving the first-step model includes selecting the first final variable targeting the important variables included in a certain information domain (F).

14. The method for operating the credit evaluation model of claim 10, further comprising:
a step of performing a credit rating of a new user based on log data of the new user by using the first-step model to which the first final variable is applied and the second-step model to which the second final variable is applied.

15. A credit evaluation server comprising:
a processor;
a memory configured to load a computer program executed by the processor; and
an interface configured to exchange data generated during execution of the computer program with a user terminal,
wherein the computer program includes:
a step of receiving log data of a user from the user terminal and selecting a frequency of event codes included in the log data and important variables through at least one preprocessing process for the frequency;
a step of deriving a first-step logistic regression mode by using the important variables as input variables and using information on the user's credit as a dependent variable;
a step of selecting a first final variable to be applied to the first-step model among the important variables and calculating a first weighted value for the first final variable;
a step of generating a derived variable by using the first final variable and the first weighted value;
a step of deriving second-step logistic regression model by using the derived variable as an input variable and using information on the user's credit as a dependent variable; and
a step of selecting a second final variable to be applied to the second-step model from among the derived variables and calculating a second weighted value for the second final variable.

16. The credit evaluation server of claim 15, wherein
the first-step model selects the first final variable to be applied to the first-step model from among the important variables by using a step-wise selection method, and
the second-step model selects the second final variable to be applied to the second-step model from among the second derived variables by using the step-wise selection method.

17. The credit evaluation server of claim 15, wherein
the step of selecting the important variables selecting, as the important variable, the first derived variable, of which P-value obtained by univariate logistic regression analysis is less than a predetermined reference value, among the plurality of first derived variables, or the first derived variable, of which IV value is greater than a predetermined reference value, among the plurality of first derived variables, and
the IV value is derived by an <equation> below.
$$I V = {\sum }_{i} ( \% of Goods - \% of Bads ) \times W O {E}_{i} \qquad < Equation >$$
where, ‘% of Goods’ means an entire ratio of a group evaluated as good, ‘% of Bads’ means an entire ratio of a group evaluated as bad, and WOE (Weights of Evidence; hereinafter WOE) means a natural logarithm of the group evaluated as good relative to the group evaluated as bad.

18. The credit evaluation server of claim 15, further comprising:
a step of grouping variables belonging to a same information domain (F) for the selected important variables, and
wherein the step of deriving the first-step model includes selecting the first final variable targeting the important variables included in a certain information domain (F).

19. The credit evaluation server of claim 15, further comprising:
a step of performing a credit rating of a new user based on log data of the new user by using the first-step model to which the first final variable is applied and the second-step model to which the second final variable is applied.

20. A computer-readable recording medium in which a program capable of executing the method according to claim 1 is recorded.
